(19) United States
(12) Patent Application Publication
(10) Pub. No.: US 2007/0052699 A1
(43) Pub. Date: Mar. 8, 2007

(54) Colour ratios in a 3d image display device

(75) Inventors: Gerardus P. Karman, S-Hertogenbosch (NL); Siebe T. De Zwart, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLPS ELECTRONICS N.V., 5621 BA EINDHOVEN THE NETHERLAND (NL)

(21) Appl. No.: 10/574,141

(22) PCT Filed: Sep. 30, 2004
(86) PCT No.: PCT/IB04/51925

§ 371 Date: Mar. 29, 2006

(30) Foreign Application Priority Data
Oct. 4, 2003 (GB) 0323279.0

(51) Int. Cl. G06T 15/00

(52) U.S. Cl. 345/419

(57) ABSTRACT

A display device for displaying a three dimensional image such that different views are displayed according to the viewing angle has a display panel with a plurality of separately addressable pixels for displaying said image. The pixels are grouped such that different pixels in a group correspond to different views of the image. The pixels are configured in colour clusters for each physical location within the image, a cluster comprising three pixel groups each corresponding to a different primary colour. A display driver controls a transmission characteristic of each pixel to generate an image according to received image data. The drive signals applied to each pixel in the display panel are adjusted using colour correction values that vary the optical transmission of each pixel within a group and each group within a cluster so as to produce an image colour for each cluster that is independent of viewing direction.

The present invention relates to display devices, and in particular to display devices adapted to display three dimensional or stereoscopic images.

The generation of three-dimensional images generally requires that a display device is capable of providing a different view to the left and the right eye of a user of the display device. This can be achieved by providing a separate image directly to each eye of the user by use of specially constructed goggles. In one example, a display provides alternating left and right views in a time sequential manner, which views are admitted to a corresponding eye of the viewer by synchronised viewing goggles. In contradistinction, the present invention relates to classes of display devices where different views of an image can be seen according to the viewing angle relative to a single display panel. Hereinafter, these will be referred to generally as 3D display devices.

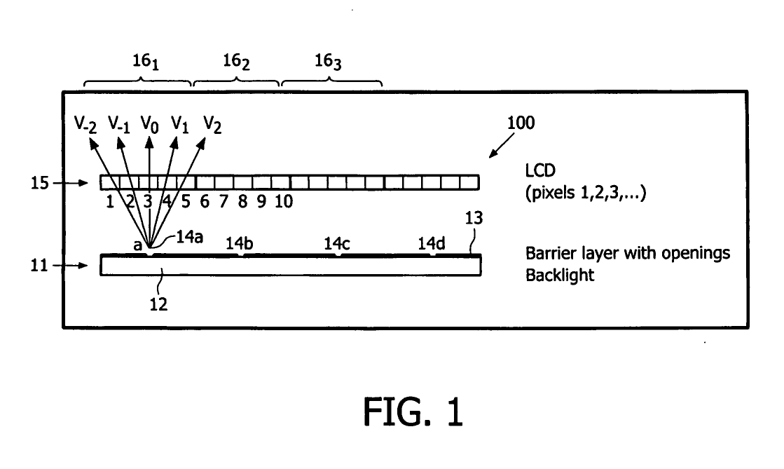

One known class of such 3D display devices is the liquid crystal display in which the parallax barrier approach is implemented. Such a system is illustrated in FIG. 1.

With reference to FIG. 1, a display device 100 of the parallax barrier type comprises a back panel 11 that provides a plurality of discrete light sources. As shown, the back panel 11 may be formed by way of an areal light source 12 (such as a photoluminescent panel) covered with an opaque mask or barrier layer 13 having a plurality of slits 14a to 14d distributed across its surface. Each of the slits 14 then acts as a line source of light.

A liquid crystal display panel (LCD) 15 comprises a plurality of pixels (eg. numbered 1 to 10 in FIG. 1) which are separately addressable by electrical signals according to known techniques in order to vary their respective light transmission characteristics. The back panel 11 is closely positioned with respect to the LCD panel 15 such that each of the line sources 14 of light corresponds to a group 16 of pixels. For example, pixels 1 to 5 shown as group 16₁ correspond to slit 14a, pixels 6 to 10 shown as group 16₂ correspond to slit 14b, etc.

Each pixel of a group 16 of pixels corresponds to one view V of a plurality of possible views (V₋₂, V₋₁, V₀, V₁, V₂) of an image such that the respective line source 14a can be viewed through one of the pixels 1 to 5 corresponding to that view. The number of pixels in each group 16 determines the number of views of an image present, which is five in the arrangement shown. The larger the number of views, the more realistic the 3D effect becomes and the more oblique viewing angles are provided.

Throughout the present specification, we shall refer to the ‘image’ being displayed as the overall image being generated by all pixels in the display panel, which image is made up of a plurality of ‘views’ as determined by the particular viewing angle.

A problem exists with this prior art arrangement. The light transmission coefficient of each pixel in the LCD panel is strongly dependent upon the viewing angle. Thus, if all pixels 1 to 5 are driven equally, the viewed intensity of source 14a will appear different for different views. For example, V₀ will be different than V₂. Similarly, the light transmission coefficient of each pixel in the LCD panel 15 is strongly dependent upon colour (ie. wavelength). Thus, the viewed intensity of the source will appear different for different colours.

Since such displays rely upon providing different pixels (and different groups 16 of pixels) for each of the three primary colours (eg. RGB), these artefacts mean that the rendering of a particular colour will vary as a function of the viewing angle. This results in a sub-optimal image and unwanted colour artefacts when observing the different views of the image.

US 2003/0052836 describes a three-dimensional image apparatus which uses a specially constructed shading mask with multiple colour filters, positioned in front of colour display device. The shading mask serves to maintain a brightness ratio of the three primary colours at different viewing angles.

It is an object of the present invention to overcome or mitigate the unwanted colour artefacts in a display device for displaying three dimensional images in which different views of the image are displayed according to the viewing angle.

According to one aspect, the present invention provides a display device for displaying a three dimensional image such that different views are displayed according to the viewing angle, the display device including:

a display panel having a plurality of separately addressable pixels for displaying said image, the pixels being grouped such that different pixels in a group correspond to different views of the image;

a display driver for controlling an optical characteristic of each pixel to generate a colour image according to received image data; and

a colour compensation device for further controlling said optical characteristic of at least some pixels within a group to compensate for a predetermined viewing angle dependency of said optical characteristic.

According to another aspect, the present invention provides a method for displaying an image on a display device such that different views of the image are displayed according to the viewing angle, the method comprising the steps of:

processing image data to form pixel data values for each one of a plurality of separately addressable pixels (0 . . . 10) in display panel (15, 53), the pixels being grouped such that different pixels in a group (16) correspond to different views of the image, the pixel data values each for controlling an optical characteristic of each pixel to generate an image;

applying colour correction values to at least some pixel data values within each group to compensate for a predetermined viewing angle dependency of said optical characteristic; and

using said corrected pixel data values to drive pixels of a display panel to generate said image.

Embodiments of the present invention will now be described by way of example and with reference to the accompanying drawings in which:

FIG. 1 shows a schematic cross-sectional view of an existing design of LCD device that uses the parallax barrier approach to display three dimensional images;

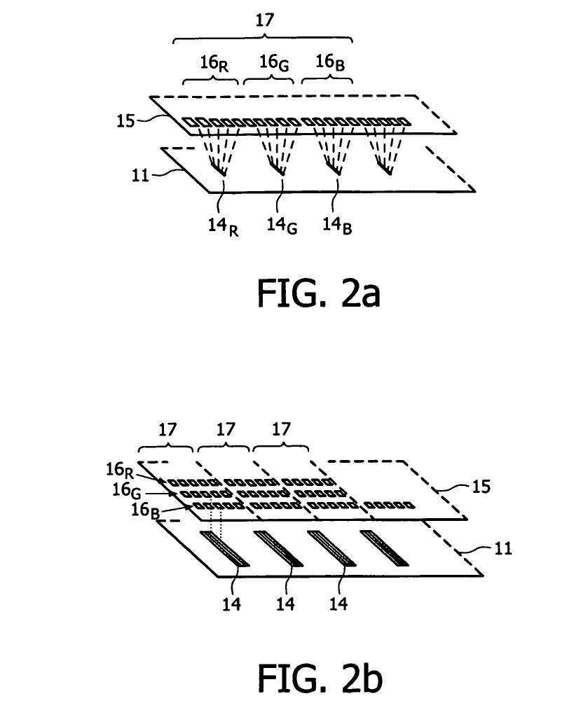

FIG. 2a shows a schematic perspective view of a portion of an LCD display juxtaposed with a back panel light source;

FIG. 2b shows a schematic perspective view of a portion of an LCD display juxtaposed with a back panel light source;

FIG. 2c shows a schematic cross-sectional diagram useful in illustrating the geometry of a parallax barrier LCD device;

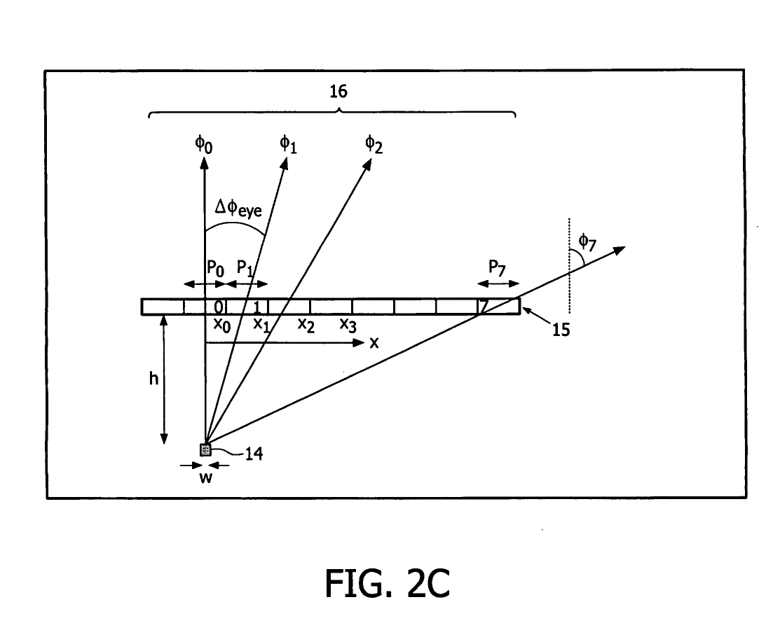

FIG. 3 shows a transmission versus voltage curve for a 90 degree twisted nematic LCD for a viewing angle of φ=0 (ie. normal to the plane of the display) for each of the three primary colours and a weighted average for white light;

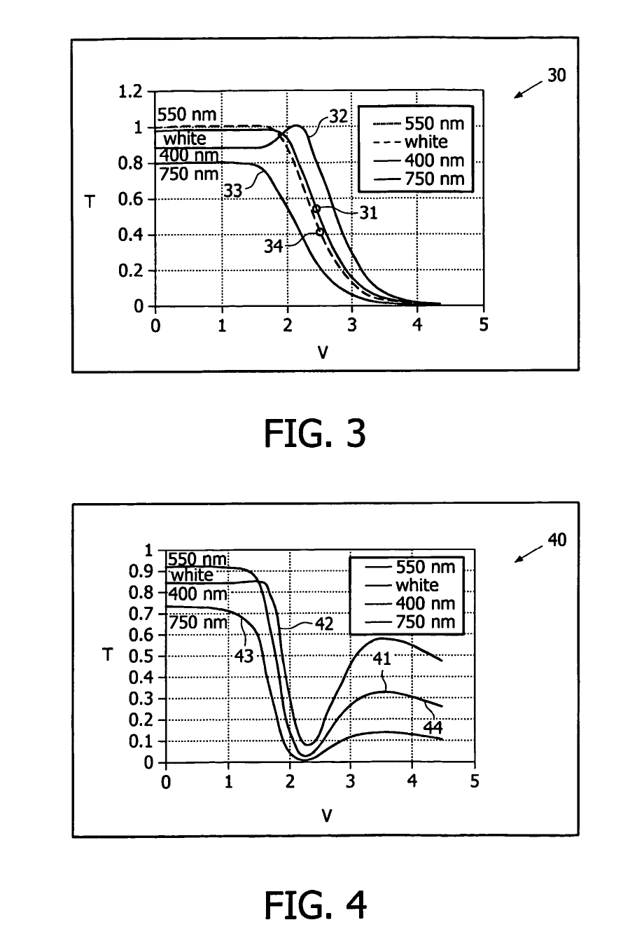

FIG. 4 shows a transmission versus voltage curve for a 90 degree twisted nematic LCD for a viewing angle of φ=60 for each of the three primary colours and a weighted average for white light;

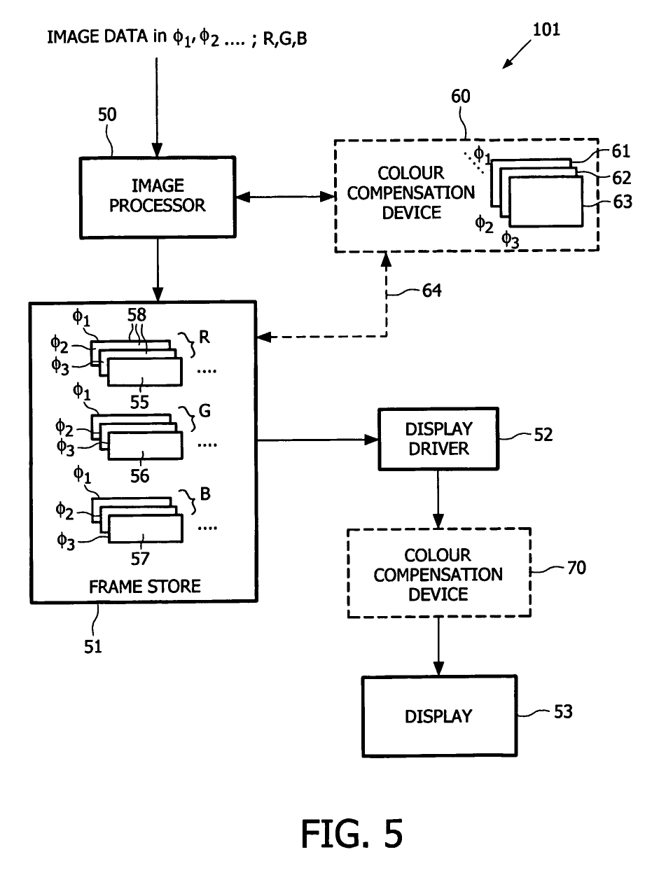

FIG. 5 shows a schematic block diagram of a display device according to embodiments of the present invention;

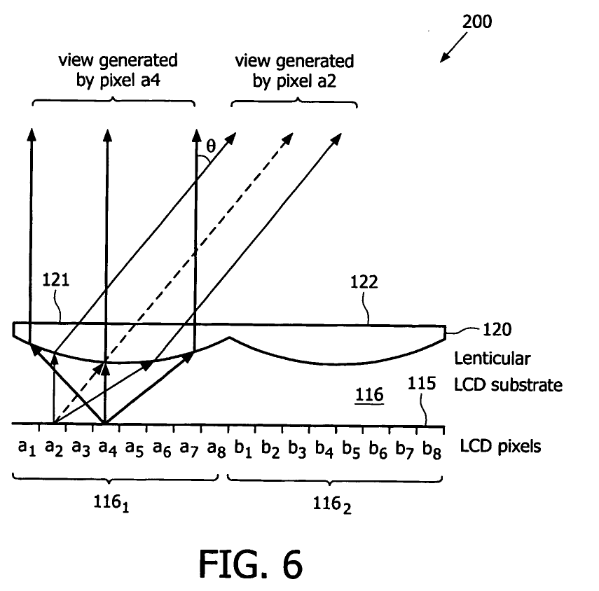

FIG. 6 shows an embodiment of the invention utilising a lenticular array;

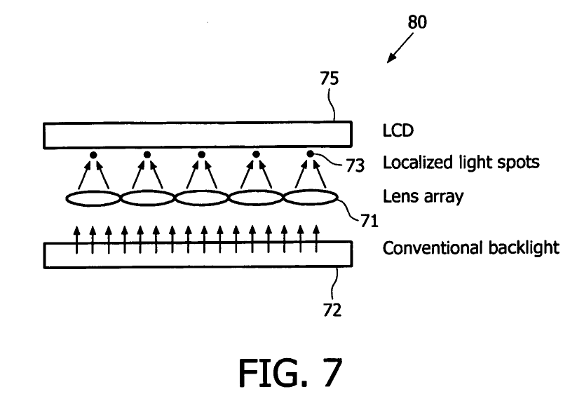

FIG. 7 shows an alternative form of light source suitable for use with the display device; and

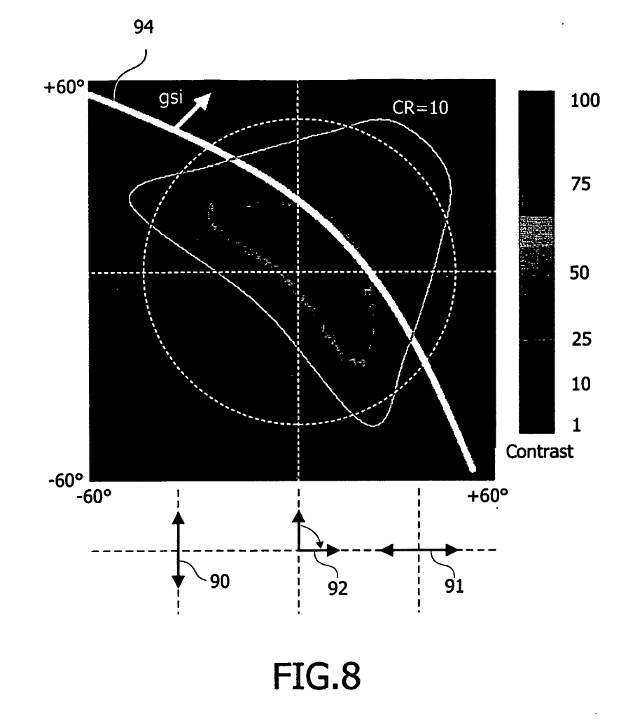

FIG. 8 shows a graph of viewing angle properties of a conventional liquid crystal display panel useful in illustrating display optimisation principles in accordance with the present invention.

With reference to FIG. 1, the basic function of a parallax barrier type, three dimensional image display device has already been described. A similar structure of display panel 15 and back panel 11 illumination source may be used in the preferred embodiment of the invention. However, it will be recognised that other configurations may be used as will become evident hereinafter.

In general, the invention uses a display panel 15 having a plurality of separately addressable pixels 1 . . . 10, in which the pixels are grouped so that the different pixels 1 . . . 5 or 6 . . . 10 respectively in a group 16₁ and 16₂ correspond to different views of the image. The display panel 15 may be any suitable electro-optical device in which an optical characteristic of each pixel can be varied according to an electrical control signal to generate an image. Preferably the display panel is a liquid crystal display.

An illumination source having a plurality of discrete light sources 14a . . . 14d so that each group 16 of pixels is positioned to receive light from a respective one of the light sources, is preferably provided. This may be by way of the areal light source 12 and mask 13 arrangement of FIG. 1, but could also be provided by way of a pixellated light source providing light is sources 14 as lines of pixels, individual pixels or blocks of pixels.

Still further, the plurality of discrete light sources could be virtual light sources provided by way of a backlight and lens array (e.g. a lenticular sheet array) providing a series of high intensity light spots. Such an arrangement is illustrated in FIG. 7. A display device 80 includes an LCD panel 75, areal light source 72 and a lens array 71. The lens array focuses light from the areal source 72 into a plurality of discrete focal points 73 just outside the plane of the LCD panel so that each illuminates a plurality of pixels in the LCD panel, similar to that described in connection with FIG. 1.

With reference to FIG. 2a, each group 16 of pixels in the display panel 15 corresponds to one physical spatial location 17 in the image. There may be three separate, closely spaced groups 16_{R}, 16_{G}, 16_{B} of pixels for each physical location 17, one group for each primary colour, thereby forming a cluster 17 of pixels that provides an effective perceived colour for that physical location, according to known colour display techniques.

The display device may include a display panel 15 that includes pixels that absorb or reflect light of certain wavelengths in order that each pixel imparts a specific colour and intensity to the views of a white light source 14 that is shared between them, as shown schematically in FIG. 2b. In that case, each pixel group 16_{R}, 16_{G} and 16_{B} in a colour cluster 17 would be selected to absorb light at different wavelengths (e.g. by incorporation of appropriate colour filters in the display panel).

Alternatively, as shown in FIG. 2a, each group 16 of pixels in a colour cluster 17 may be positioned relative to one of a possible three different primary colours of light source. Thus, light source 14_{R} may be red, light source 14G may be green, and light source 14_{B} may be blue. Pixel groups 16_{R}, 16_{G}, 16_{B} would then form a colour cluster 17.

Part of a group of pixels in the display panel 15 is shown in FIG. 2c. A light source 14 of width w corresponds with, and can be viewed through, a group of pixels 0 . . . 7 at respective viewing angles φ₀, φ₁, . . . φ₇ relative to the normal of the plane of the display panel. It will be understood that only half of the pixel group 16 is shown, a further seven pixels being present to the left of pixel 0 to complete the pixel group 16.

Each pixel has a width p₀, p₁, . . . p₇. Preferably, widths p₀ . . . p₇ are equal, but they could vary in order to compensate to a certain extent for the angle of incidence of light passing therethrough. The distance between the back panel illumination source 14 and the display panel 15 is shown as h. In a preferred display device, h=2.3 mm, p₀=200 microns, and w=50 microns although these values may be varied significantly.

FIG. 3 shows a transmission (T) versus voltage (V) characteristic 30 for a display panel 15 in the form of a 90 degree twisted nematic LCD for the viewing angle φ=0 degrees (e.g. pixel 0). The curves for transmission of red, green and blue wavelengths are shown respectively as curves 33, 34, 32. A fourth curve 31, representing white light, is a weighted average to model white light. It will be noted that the transmission coefficient of light for a pixel operating under a drive voltage in the range 0 to 1 V varies between approximately 0.8 and 1.0 according to the light wavelength.

FIG. 4 shows a transmission (T) versus voltage (V) characteristic 40 for a display panel 15 in the form of a 90 degree twisted nematic LCD for the viewing angle φ=60 degrees (e.g. pixel 7). The curves for transmission of red, green and blue wavelengths are shown respectively as curves 43, 44, 42. A fourth curve 41, representing white light, is a weighted average to model white light. It will be noted that the transmission coefficient of light for a pixel operating under a drive voltage in the range 0-1 V varies between approximately 0.73 and 0.92 according to the light wavelength.

With reference to FIG. 3, in order to produce a ‘white’ view from a pixel colour cluster, one could provide each of the three RGB pixels with approximately the same driving voltage. However, the RGB pixels would then appear to have somewhat different luminance, resulting not in a white image pixel but in a slightly coloured pixel (typically somewhat yellow in appearance). It is possible to compensate for this by deliberately driving the different RGB pixels at different voltages in order to obtain the same luminance from each colour pixel thereby rendering a true white colour to the pixel colour cluster.

However, it is apparent from FIG. 4 that the optimal choice of voltages at which to drive the three different RGB pixels is a function of the angle at which the display panel is viewed. Thus, the driving voltages established for an ideal ‘white’ colour viewed through the pixel 0 is sub-optimal for all other pixels 1 to 7.

The present invention provides a colour compensation device that controls the optical characteristic of each pixel 0 . . . 7 in a group 16 so as to compensate for the viewing angle. Thus, a colour correction factor applied to each red pixel in group 16_{R} will be varied according to pixel position 0 . . . 7 within the group. Similarly, a colour correction factor applied to each green pixel in group 16_{G} will also be varied according to pixel position 0 . . . 7 within the group. Similarly, a colour correction factor applied to each blue pixel in group 16_{B} will also be varied according to pixel position 0 . . . 7 within the group. Note that, in general, these three colour correction factors will be different. The colour compensation device preferably substantially normalises a colour displayed by a group 16 of pixels to that of the other groups of pixels for a given location or colour cluster in the display panel. The colour rendering thereby becomes independent of the viewing angle. The expression normalisation of colour may be taken to mean the normalisation of absolute intensity of each colour and also the colour point in the colour triangle.

Different colour correction factors will be required for different display types and for transmissive versus reflective displays. Appropriate colour correction factors can be determined from appropriately generated transmission/reflection coefficients determined according to techniques known to the person skilled in the art.

The examples shown in FIGS. 3 and 4 were determined for Simulations of the optical transmission were carried out for a LCD with the following configuration. The LCD has a cell gap of 4.75 microns and was filled with liquid crystal material ZLI-4792, having indices of refraction nₒ=1.4794, nₑ=1.5794. Typical elastic constants of this material are splay/twist/bend constants respectively of 13.2e-12 N/6.4e-12 N/19.8e-12 N respectively. The alignment was such that a 90 degree TN mode was obtained and, more specifically, the e-mode configuration with crossed polarizer. The alignment of the LC was assumed to have a pre-tilt of 2.5 degrees on both substrates.

FIG. 5 shows schematically exemplary embodiments of a display device 101 that incorporates a colour compensation device.

An image processor 50 receives a stream of image information including RGB pixel data for each of a plurality of views φ₀ . . . φ₇. The image information is processed and stored into a frame buffer 51 in digital form so that it can be rendered onto a display device 53. Frame buffer 51 includes a plurality of pages 58, for example arranged in three colour sets 55, 56, 57. Each set corresponds to one of the three primary colours, RGB. Each set 55, 56, 57 includes the pixel data for each view, φ₀, φ₁, . . . φ₇, i.e. for each pixel group 16.

The frame buffer 51 is accessed by a display driver 52 that provides appropriate drive voltage an/or current signals to each pixel of a display panel 53 in accordance with each of the stored values in frame store 51. As a general principle, it will be understood that the application of colour correction values by a colour compensation device can be applied either:

(i) by digitally modifying the image data stored in the frame store 51 to include a correction factor so that the value of drive parameter selected by the display driver 52 is suitably modified, or

(ii) by leaving the image data stored in the frame store 51 unmodified, but applying a correction factor to the output of the display driver 52.

In a first embodiment, a colour compensation device 60 (shown in dashed outline) is provided as, for example a look-up table accessible by the image processor 50. The look-up table comprises a plurality of pages 61, 62, 63 of correction values, each page corresponding to one of the viewing angles φ₁ . . . φ₇ to be applied to image data received by the image processor. The image processor 50 obtains appropriate corrections to the image data and stores this compensated data in frame store 51.

The expression ‘correction values’ in this context may include ‘substitution’ values or ‘offset’ values. In other words, for a given input pixel value xᵢ, the look-up tables 61-63 may provide a substitution value xₛ (as a function of φ) to be stored in the frame store in place of xᵢ. Alternatively, for a given input pixel value xᵢ, the look-up tables 61-63 may provide an offset value xₒ (as a function of φ) which is combined with the input value and the result xᵢ+xₒ stored in the frame store in place of xᵢ.

A particular advantage of this embodiment is that it can be implemented with very little, if any, change in hardware from a conventional LCD driver arrangement. The functions of the image processor 50 can be realised in software, and the functions of the colour compensation device 60 can also be realised as a software implementation.

In a variation on this first embodiment, the compensation device 60 may operate independently of the image processor 50 upon data already stored in the frame store 51 by the image processor 50. This can be effected by using a second access port 64 to the frame store 51. The compensation device 60 in this embodiment may also be implemented as a software module, without interfering with the operation of the image processor 50 (for example, where this is a customised graphics processor). Again, the look-up tables 61-63 may provide a substitution value or an offset value to be implemented by the colour compensation device.

In a second embodiment, it is recognised that the colour compensation for each pixel drive signal could be carried out in real time in the analogue domain, i.e. by applying a correction voltage offset to each pixel signal produced by the display driver 52. Thus, in this embodiment, a colour correction device 70 is installed between the display driver 52 and the display panel 53 to apply specific offset voltages and/or currents to those output by the display driver. In this arrangement, the colour correction values may be considered as voltage and/or current offset values.

For the sake of completeness, it is also noted that a hybrid system could deploy both techniques of digital correction values applied to the frame store 51 by compensation device 60 and analog offsets applied to the display driver outputs by compensation device 70. An appropriate contribution would be made by both, although this may be a more complicated solution. For example, analogue offsets or correction values applied by the colour compensation device 70 might be selected to move the operation of the display panel into an appropriate portion of the transmission-voltage characteristic 30, 40, while digital correction values might be selected to compensate for differences in the slope or level of the transmission-voltage characteristics.

It is also noted that the colour compensation device 60 as described herein may also be applied in other forms of 3D display other than that shown in FIGS. 1 and 2. With reference to FIG. 6, it will be noted that the invention can also be applied to a lenticular 3D display device 200. In this lenticular display device, a liquid crystal display panel 115 includes a plurality of pixels (a₁ to b₈ are shown) arranged in groups 116₁, 116₂, in similar manner to that in FIG. 1. On top of the LCD array 115 is positioned a lenticular array 120 of cylindrical lenses 121, 122. The lenticular array may include any sheet of corrugated optical material, or array of discrete or joined lenses to provide localised focusing for groups of pixels of the LCD panel.

In the arrangement shown in FIG. 6, the width of each lens element is chosen to be eight pixels, corresponding to an eight-view 3D display. Of course, the width of each lens element may be chosen to correspond to different numbers of pixels according to the angular resolution required. The pixels a, to a₈ of the LCD are imaged into the different views. For example, the light rays emitted from pixels a₂ and a₄ are shown. One sees that in the LCD substrate 116, the rays emitted by pixel a₂ propagate to a large extent obliquely with respect to the rays emitted by pixel a₄. The angle between them is, on average, approximately equal to the angle between the two views (θ).

It will be seen that in a lenticular-type 3D display device, the light rays of the different views travel through the liquid crystal layer at different angles. Therefore, the problem of colour dependency of the angle still exists, and is solved by the colour compensation device as described in connection with FIG. 5.

The invention as described above also has important implications for the optimisation of liquid crystal displays generally. The viewing angle dependence of LCD panels is known generally to be rather poor. FIG. 8 illustrates how contrast (a function of intensity) and grey scale inversion depends upon viewing angle for a standard 90 degree twisted nematic (TN) transmissive LCD without compensation foil. The horizontal viewing angle is shown on the x-axis between −60 degrees and +60 degrees from the normal to the plane of the display, and the vertical viewing angle is shown on the y-axis between −60 degrees and +60 degrees from the normal to the plane of the display.

The orientations of the optical axes 90, 91 of the LCD polarisers and the optical axes 92 of the liquid crystal directors are shown in the lower part of the figure.

From FIG. 8, it is seen that the image quality strongly depends upon viewing angle. For the example shown in FIG. 8, the optimal viewing angles are represented by the diagonal line 94 running from top left to bottom right, and grey scale inversion occurs for viewing positions to the right and above the line 94.

Conventionally, for most important applications such as televisions and computer monitors, it is recognised that maximising performance for horizontal viewing directions is more important than maximising performance for vertical viewing directions. For example, for television applications, multiple viewers of a display device will normally be arranged with their eye levels more-or-less consistent relative to the screen (i.e. with very little variation along the y-axis), but their horizontal viewing angles relative to the x-axis may vary significantly. Similarly, a user seated at a computer monitor is more likely to vary head position along the x-axis while working, than along the y-axis.

According to convention, therefore, the LCD would be rotated anticlockwise through 45 degrees from the orientation shown in FIG. 8, such that its polarisation axes are at approximately 45 degrees to the x- and y-axes of the display when in use. In this way, the performance of the display device is optimised for horizontal viewing angles, but is compromised for vertical viewing angles.

3D LCD displays suffer from the same problems with optimisation of viewing angle dependency in respect of x and y directions.

However, in the present invention, it is recognised that optimisation of colour rendering can be achieved by electronic techniques in driving the display, using the described colour compensation device 60 and/or 70 as described above.

Therefore, it is more appropriate to provide the display device with an orientation in which the inherent optical characteristics of the display panel are optimised for vertical viewing angle variations. Horizontal viewing angle variations are accommodated for and optimised using the electronic driving techniques as described herein.

Thus, in a preferred arrangement, the 3D display device described above is arranged so that, in normal use, it has the pixels within each group 16 that provide different views as a function of angle to a first axis of the display panel, and has the polarising elements of the display panel oriented so as to minimise viewing angle dependence relative to a second axis of the display, where the second axis is orthogonal to the first axis.

In a most general sense, the inherent optical characteristics of the display panel are such that viewing angle dependence is reduced or substantially minimised relative to the y-axis and the colour compensation device 60 and/or 70 serves to reduce or substantially minimise viewing angle dependence relative to an axis that is transverse to the y-axis. More preferably, the colour compensation device 60 and/or 70 serves to reduce or substantially minimise viewing angle dependence relative to an axis that is orthogonal to the y-axis (i.e. the x-axis). In a most preferred device, the x-axis is defined as the horizontal axis when the display is in normal use, and the y-axis is defined as the vertical axis when the display is in normal use.

Other embodiments are intentionally within the scope of the accompanying claims.

1. A display device (101) for displaying a three dimensional image such that different views are displayed according to the viewing angle, the display device including:
a display panel (15, 53) having a plurality of separately addressable pixels (0 . . . 10) for displaying said image, the pixels being grouped such that different pixels in a group (16) correspond to different views of the image;
a display driver (52) for controlling an optical characteristic of each pixel to generate an image according to received image data; and
a colour compensation device (60, 70) for further controlling said optical characteristic of at least some pixels within a group to compensate for a predetermined viewing angle dependency of said optical characteristic.

2. The display device of claim 1 further including a back panel (11) for providing a plurality of discrete sources (14) of illumination, each group (16) of pixels in the display panel (15) being positioned to receive light from a respective one of the discrete sources of illumination.

3. The display device of claim 2 in which the back panel (11) provides a plurality of line sources of illumination.

4. The display device of claim 2 in which the back panel (11) provides a plurality of point sources of illumination.

5. The display device of claim 2 in which the display panel (15) is a light-transmissive display panel adapted for viewing from a side opposite to the side on which the back panel (11) is located.

6. The display device of claim 1 further including a lenticular array (120) positioned adjacent to the display panel (115), each lenticle (121, 122) within the array focusing light from selected pixels in the display panel.

7. The display device of claim 6 in which each lenticle (121, 122) within the array (120) is associated with a said group (16) of pixels.

8. The display device of claim 1 in which the optical characteristic is a light transmission characteristic and the display driver (52) and colour compensation device (60, 70) are adapted to control the amount of light passing through each pixel according to a three dimensional colour image to be displayed.

9. The display device of claim 1 in which the colour compensation device (60) comprises a look-up table containing correction values to be applied in respect of each pixel within a group.

10. The display device of claim 9 in which the correction values are selected according to the viewing angle of a respective pixel within the group (16).

11. The display device of claim 10 in which the correction values are selected so as to substantially normalise an intensity of colour and/or its colour point in the colour triangle as displayed by a group of pixels to be independent of the viewing angle.

12. The display device of claim 9 in which the look-up table includes substitution values or offset values as a function of viewing angle to be applied to a frame store.

13. The display device of claim 8 in which the colour compensation device is adapted to adjust a pixel drive voltage received from the display driver.

14. The display device of claim 1 in which the display panel includes colour clusters for each physical location within the image, a cluster comprising a plurality of said pixel groups each corresponding to a different primary colour, the colour compensation device adapted to control the optical characteristic of each pixel within a group and each group within a cluster so as to produce an image colour for each cluster that is independent of viewing direction.

15. The display device of claim 1 in which the inherent optical characteristics of the display panel (15, 53) are configured such that viewing angle dependence is reduced or substantially minimised relative to the y-axis and the colour compensation device (60, 70) serves to reduce or substantially minimise viewing angle dependence relative to an axis that is transverse to the y-axis.

16. The display device of claim 15 in which the colour compensation device (60, 70) serves to reduce or substantially minimise viewing angle dependence relative to an axis that is orthogonal to the y-axis (i.e. the x-axis).

17. The display device of claim 16 incorporated into an object, in which the x-axis is defined as the horizontal axis when the object is in normal use, and the y-axis is defined as the vertical axis when the object is in normal use.

18. A method for displaying a three dimensional image on a display device such that different views of the image are displayed according to the viewing angle, the method comprising the steps of:
processing image data to form pixel data values for each one of a plurality of separately addressable pixels (0 . . . 10) in display panel (15, 53), the pixels being grouped such that different pixels in a group (16) correspond to different views of the image, the pixel data values each for controlling an optical characteristic of a respective pixel to generate an image;
applying colour correction values to at least some pixel data values within each group to compensate for a predetermined viewing angle dependency of said optical characteristic; and
using said corrected pixel data values to drive pixels of a display panel to generate said image.

19. The method of claim 18 in which the optical characteristic is a light transmission characteristic and the colour correction values applied are adapted to control the amount of light passing through each pixel according to a three dimensional colour image to be displayed.

20. The method of claim 18 in which the colour correction values are obtained from a look-up table containing correction values to be applied in respect of each pixel within a group.

21. The method of claim 19 in which the correction values are selected according to the viewing angle of a respective pixel within the group (16).

22. The method of claim 21 in which the correction values are selected so as to substantially normalise a colour and/or its colour point in the colour triangle as displayed by a group of pixels to be independent of the viewing angle.

23. The method of claim 18 in which the colour correction values are derived from a transmission versus voltage characteristic of the display panel, the corrected pixel data values being used to adjust a pixel drive voltage applied to the display panel.

24. The method of claim 18 in which the pixels are configured in colour clusters for each physical location within the image, a cluster comprising a plurality of said pixel groups each corresponding to a different primary colour, the colour correction values being adapted to control the optical characteristic of each pixel within a group and each group within a cluster so as to produce an image colour for each cluster that is independent of viewing direction.

25. The method of claim 18 further including the step of configuring the inherent optical characteristics of the display panel (15, 53) such that viewing angle dependence is reduced or substantially minimised relative to the y-axis and applying said colour correction values so as to reduce or substantially minimise viewing angle dependence relative to an axis that is transverse to the y-axis.

26. The method of claim 25 in which the colour correction values are applied to reduce or substantially minimise viewing angle dependence relative to an axis that is orthogonal to the y-axis (i.e. the x-axis).

27. The method of claim 26 in which the x-axis is the horizontal axis when the display panel is in normal use, and the y-axis is the vertical axis when the display panel is in normal use.

28. A computer program product, comprising a computer readable medium having thereon computer program code means adapted, when said program is loaded onto a computer, to make the computer execute the procedure of claim 18.

29. A computer program, distributable by electronic data transmission, comprising computer program code means adapted, when said program is loaded onto a computer, to make the computer execute the procedure of claim 18.
